(19) United States
(12) Patent Application Publication
(10) Pub. No.: US 2021/0309044 A1
(43) Pub. Date: Oct. 7, 2021

(54) Sticker application system and method

(71) Applicant: Suzanne "Suki" Shair, New York, NY (US)

(72) Inventor: Suzanne "Suki" Shair, New York, NY (US)

(21) Appl. No.: 17/146,225

(22) Filed: Jan. 11, 2021

Related U.S. Application Data
(60) Provisional application No. 62/959,226, filed on Jan. 10, 2020.

(51) Int. Cl. B44C 1/10; D06Q 1/14

(52) U.S. Cl. CPC B44C 1/105; A41D 27/08; D06Q 1/14

(57) ABSTRACT

A sticker application system includes a fabric, a heat transfer permanent vinyl attached to the fabric and non-permanent adhesive material temporarily adhered to the permanent vinyl. The non-permanent adhesive material contains at least one of a design or graphics. The vinyl permanently adhered to the fabric by heat transfer is washable. The non-permanent adhesive backed vinyl is temporarily adhered to the permanent heat transfer vinyl for a transferable, re-useable, changeable use. The permanent and non-permanent vinyl combination is a unique platform suitable for decoration, methods including but not limited to stickers, sticker design sets, stencil drawings, hand drawings, art and expression. A sticker application method provides a temporary, transferable, reusable, changeable way to self-design fabrics.

### CROSS-REFERENCE TO RELATED APPLICATIONS

This document claims the benefit and priority of U.S. Prov. App. Ser. No. 62/959,226 (filed Jan. 10, 2020) with a title of “Sticker application system and method.” That provisional application is incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter relates to a sticker application system and a sticker application method which permit a user to temporarily apply stickers to a fabric, such as clothing, to remove the stickers and to share the stickers with other users who can apply them to other fabrics and use them repeatedly.

### Background of the Invention

Prior art sticker application systems and methods required the stickers to be permanently applied to a fabric or, if the stickers were removed, they were not reusable and had to be discarded. That made it impossible to use the same fabric with different stickers and to use the same sticker on other fabrics.

### SUMMARY OF THE INVENTION

It is accordingly an object of the disclosed subject matter to provide a sticker application system and a sticker application method, which overcome the hereinafore-mentioned disadvantages of the heretofore-known systems and methods of this general type and which permit stickers to be reused on different fabrics, such as clothing.

Through the use of the disclosed subject matter, a drawing, stickers, any sticky backed designs, colorforms, labels and, including but not limited to, an artful expression, may be adhered to a wearable or non-wearable fabric or material gear, such as clothing, bags, linen, etc.

The disclosed subject matter provides the opportunity to change a design and/or an expression as wanted on a material or fabric. This platform is designed to provide a canvas for stickers, re-useable and not, to stick the material that houses the application on the permanent vinyl attachments. The adhesive backed vinyl and/or sticker(s) will temporarily attach and be available for change within the same day or sooner.

This is a unique combination for the purpose of sticking re-useable and non-reusable stickers multiple times, as well as an interactive, interchangeable, personal, and temporary design of, including but not limited to, expression, art, thought, and creativity. This product will represent a self-made design, reusable and changeable on a T-shirt or other fabrics/materials. Any singular or combination of re-useable stickers, regular stickers, labels, adhesive backed items, etc. can be placed in any area or group of areas of a garment or fabric. The designated area of permanent vinyl can be in any area(s), size(s), shape, color, and/or position.

The disclosed subject matter creates an innovative, new, platform, canvas, combination of materials to express an idea, thought, design, with pictures, self-drawn or already made/created that can be changed immediately since it is a temporary, transferrable, reusable design.

With the foregoing and other objects in view there is provided, in accordance with the disclosed subject matter, a sticker application system, comprising a fabric, a heat transfer permanent vinyl attached to the fabric, and non-permanent adhesive material temporarily adhered to the permanent vinyl, the non-permanent adhesive material containing at least one of a design or graphics.

In accordance with another feature of the disclosed subject matter, the fabric is selected from the group consisting of gear and wearables including but not limited to T-shirts, pants, bags, hats, linens, shoes and jackets.

In accordance with a further feature of the disclosed subject matter, the heat transfer permanent vinyl is an iron-on.

In accordance with an added feature of the disclosed subject matter, the design or graphics are selected from the group consisting of labels, drawings, words, logos and pictures.

With the objects of the disclosed subject matter in view, there is concomitantly provided a sticker application method, which comprises attaching a heat transfer permanent vinyl to a fabric; and temporarily adhering a non-permanent adhesive material to the permanent vinyl, the non-permanent adhesive material containing at least one of a design or graphics.

Other features which are considered as characteristic for the disclosed subject matter are set forth in the appended claims.

Although the disclosed subject matter is illustrated and described herein as embodied in a sticker application system and a sticker application method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a diagrammatic, top-plan view of a piece of fabric to which the sticker application system according to the invention has been applied;

FIG. 2 is a top-plan view of T-shirts to which the sticker application system according to the invention has been applied;

FIG. 3 is a top-plan view of T-shirts to which the sticker application system according to the invention has been applied;

FIG. 4 shows a sweatshirt, t-shirt, facemask, headband, arm or wrist band, and a yarmulke that may be part of the disclosed sticker application system; and,

FIG. 5 shows a preferred method involving a shirt with a permanent vinyl surface 100, a temporary vinyl surface 150, and a sticker 155.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed generally is a sticker application system and a sticker application method which permit stickers to be reused on different fabrics, such as clothing. Through the use of the system, a drawing, stickers, any sticky backed designs, colorforms, labels and, including but not limited to, an artful expression, may be adhered to a wearable or non-wearable fabric or material gear, such as clothing, bags, linen, etc. The system provides the opportunity to change a design and/or an expression as wanted on a material or fabric. This platform is designed to provide a canvas for stickers, re-useable and not, to stick the material that houses the application on the permanent vinyl attachments. The adhesive backed vinyl and/or sticker(s) will temporarily attach and be available for change within the same day or sooner. The details of the system are disclosed with reference to the FIGURES.

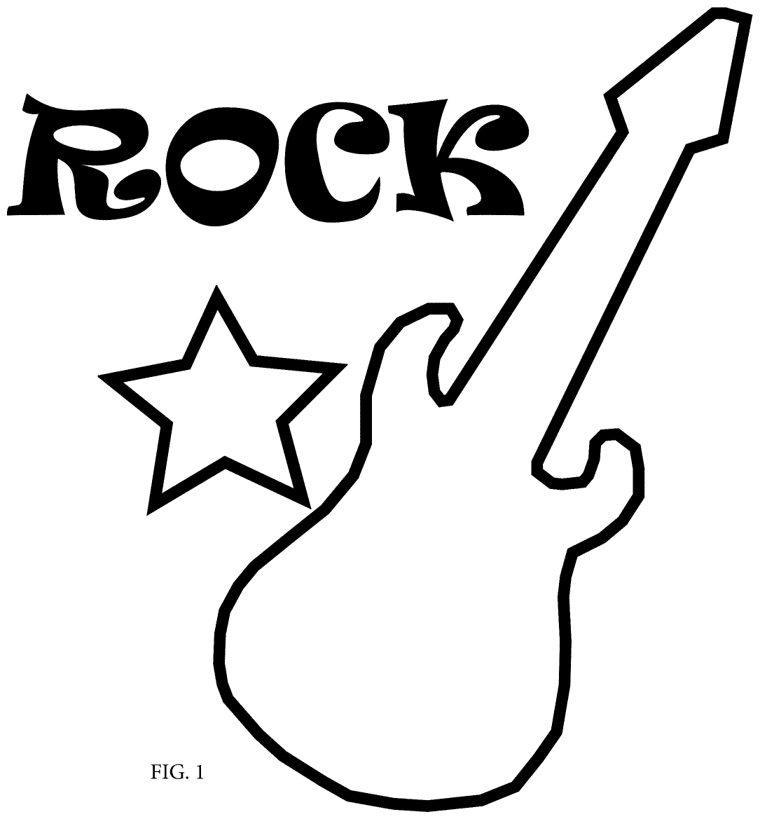

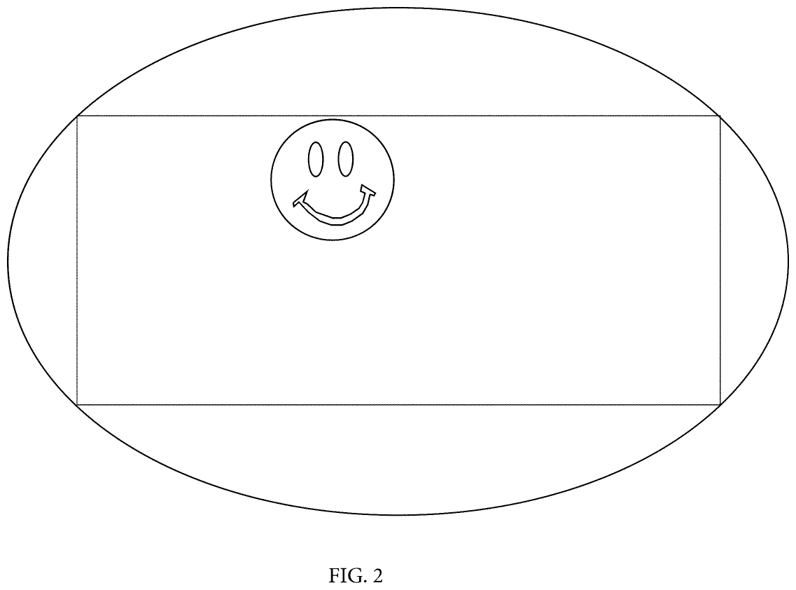

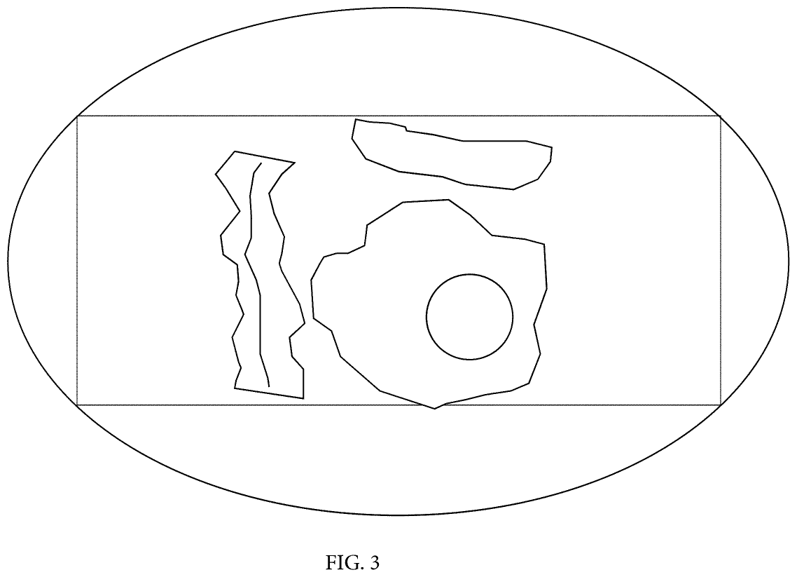

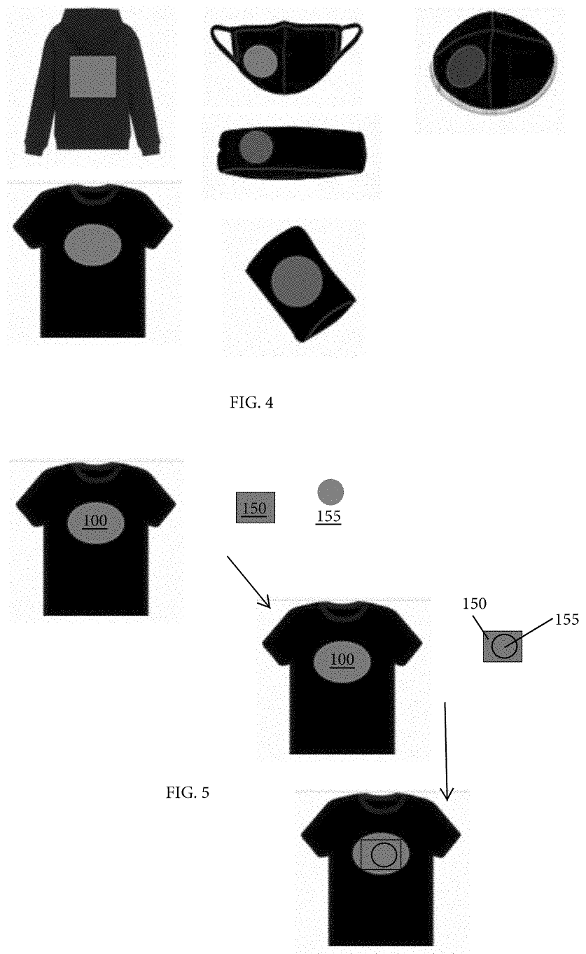

Referring now to the figures of the drawings in detail and first, particularly, to FIG. 1 thereof, there is seen a fabric to which the letters ROCK, a star design and a guitar design are adhered. FIGS. 2 and 3 show T-shirts to which other designs in the form of faces and breakfast food, respectively, have been applied. FIG. 4 shows a few clothing items that may incorporate aspects of the present system.

FIG. 5 shows a preferred method involving a shirt with a permanent vinyl surface 100, a temporary vinyl surface 150, and a sticker 155. According to the preferred embodiment, in a first step, a heat transfer permanent vinyl 100 is attached to a fabric. In a second step, one or more designs 155 on non-permanent adhesive material 150 including drawings, stickers (e.g., paper sticker with adhesive backing), labels or colorforms are created. In a third step, the non-permanent vinyl stickers 150+155 are attached to the permanent vinyl 100. Of course, the second step may be performed first. During the third step, caution must be used since any area of the adhesive of the non-permanent adhesive material 150 not directly attached to the permanent vinyl 100 will pick up fabric lint from the material which may make it more difficult to use the non-permanent adhesive material 150 again.

The non-permanent adhesive material may be taken off and replaced as desired, but it is not recommended to keep a non-permanent vinyl sticker on the heat transfer permanent vinyl longer than 12-14 hours.

The permanent vinyl on the fabric may be placed in the wash without the non-permanent vinyl. The non-permanent vinyl may be saved, reused, shared, or discarded as desired. In order to best save, share and reuse the stickers, all of the stickers designs on the non-permanent vinyl should to be placed in a sticker book.

The system provides a unique process using specific materials and a combination of materials to allow for stickers to adhere directly and indirectly to a fabric, material garment, T-shirt, etc. A piece of any size, any shape, any color, any position or placement of a permanent vinyl, currently a heat transfer vinyl (for example Siser Easyweed (heat transfer vinyl material) or Specialty Materials Thermoflex (heat transfer vinyl material)) may be used. The permanent vinyl is attached by way of heat transfer application to a fabric, gear, wearables including but not limited to a T-shirt, pants, bags, hats, linens, shoes, jackets etc. A vinyl adhesive backed indoor/outdoor vinyl sticker (for example a type made from vinyl known as Oracle 631/651 with an adhesive backing of Oracle 931/951) then attaches/adheres to the already permanently adhered heat transfer vinyl (such as an iron on). This transferrable outer layer is a non-permanent, transferable, temporary canvas for a design. It is an adhesive platform to house a self-designed sticker, label, drawing, including but not limited to words, logos, pictures, creative ideas, etc.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A sticker application system, comprising:
a fabric;
a heat transfer permanent vinyl attached to said fabric; and
non-permanent adhesive material temporarily adhered to said permanent vinyl, said non-permanent adhesive material containing at least one of a design or graphics that was applied to the non-permanent adhesive material before adhesion to said permanent vinyl.

2. The system according to claim 1, wherein the fabric is incorporated into clothing selected from the group consisting of gear and wearables including T-shirts, pants, bags, hats, linens, shoes and jackets.

3. The system according to claim 1, wherein said heat transfer permanent vinyl is an iron-on.

4. The system according to claim 1, wherein said design or graphics are selected from the group consisting of labels, drawings, words, logos and pictures.

5. A sticker application method, which comprises:
attaching a heat transfer permanent vinyl to a fabric; and
temporarily adhering a non-permanent adhesive material to the permanent vinyl, the non-permanent adhesive material containing at least one of a design or graphics;
wherein the at least of a design or graphics was applied to the non-permanent adhesive material prior to the step of temporarily adhering a non-permanent adhesive material.

6. The method according to claim 5, which further comprises the fabric being incorporated into clothing selected from the group consisting of gear and wearables including T-shirts, pants, bags, hats, linens, shoes and jackets.

7. The method according to claim 5, which further comprises carrying out the attaching step by ironing-on the heat transfer permanent vinyl.

8. The method according to claim 5, which further comprises selecting the design or graphics from the group consisting of labels, drawings, words, logos and pictures.
